(19) United States
(12) Patent Application Publication
(10) Pub. No.: US 2017/0275498 A1
(43) Pub. Date: Sep. 28, 2017

(54) POLISHING COMPOSITION

(71) Applicant: FUJIMI INCORPORATED, Kiyosu-shi, Aichi (JP)

(72) Inventors: Shuichi TAMADA, Kiyosu-shi, Aichi (JP); Masaki TADA, Kiyosu-shi, Aichi (JP)

(73) Assignee: FUJIMI INCORPORATED, Kiyosu-shi, Aichi (JP)

(21) Appl. No.: 15/509,272

(22) PCT Filed: Sep. 28, 2015
(86) PCT No.: PCT/JP2015/077331

§ 371 Date: Mar. 7, 2017

(30) Foreign Application Priority Data
Sep. 30, 2014 (JP) 2014-200287

(51) Int. Cl. C09G 1/02; C09K 3/14

(52) U.S. Cl. CPC C09G 1/02; C09K 3/1463; C09K 3/1409

(57) ABSTRACT

Provided is a polishing composition which is suitable for polishing an object of polishing having a layer containing a high mobility material that has higher carrier mobility than Si, suppresses excessive dissolution of the layer containing a high mobility material, and is capable of efficient polishing.

Disclosed is a polishing composition that is used for polishing an object of polishing having a layer containing a high mobility material that has higher carrier mobility than Si, the polishing composition including abrasive grains and at least one salt compound selected from the group consisting of a salt of a monovalent acid, a salt of a divalent acid, a salt of a trivalent acid, and a halide salt, in which the electrical conductivity is 1 mS/cm or higher, and a content of hydrogen peroxide is less than 0.1% by mass.

### TECHNICAL FIELD

The present invention relates to a polishing composition.

### BACKGROUND ART

In recent years, new microprocessing technologies have been developed along with high-level integration and performance enhancement of LSI. Chemical mechanical polishing (hereinafter, also simply referred to as CMP) is one of such technologies, and is a technology that is frequently utilized for the flattening of an interlayer insulating film, formation of a metal plug, and formation of embedded wiring (damascene wiring) in a LSI production process, particularly a multilayer wiring forming process. This technology is disclosed in, for example, U.S. Pat. No. 4,944,836 B. With a damascene wiring technology, wiring process can be simplified or the product yield and reliability can be enhanced.

In high-speed logic devices, or in memory devices, a representative example of which is DRAM, as damascene wiring, currently copper is mainly used as the wiring metal since copper has low resistance, and thus it is speculated that the range of use of copper will be expanded in the future even to memory devices, a representative example of which is DRAM. A general method for CMP of metals including copper involves attaching a polishing pad onto a circular polishing table (platen), immersing the surface of the polishing pad in a polishing agent, pressing the surface of the substrate on which a metal film has been formed, subsequently rotating the polishing table in a state in which predetermined pressure (hereinafter, also simply described as polishing pressure) has been applied through the back surface of the substrate, and eliminating the metal film of a convexity by means of mechanical friction between a polishing agent and the convexity of the metal film.

On the other hand, beneath the copper or copper alloy of wiring, a layer of tantalum, a tantalum alloy, a tantalum compound or the like is formed as a barrier layer for preventing copper diffusion into an interlayer insulating film. Therefore, in parts other than the wiring portion in which copper or a copper alloy is embedded, it is necessary to eliminate the exposed part of the barrier layer by CMP. However, since a barrier layer generally has high hardness compared to copper or a copper alloy, when CMP using a combination of polishing materials for copper or a copper alloy is employed, a sufficient CMP speed may not be obtained in many cases.

On the other hand, tantalum, a tantalum alloy, a tantalum compound and the like, which are all used for a barrier layer, are chemically stable, are not easily applicable to etching, and have high hardness. Therefore, mechanical polishing cannot be achieved as easily as in the case of copper or a copper alloy. In recent years, investigations have been conducted on suitability of noble metal materials such as ruthenium, a ruthenium alloy, and a ruthenium compound as the materials for barrier layers. Noble metal materials such as ruthenium, a ruthenium alloy, and a ruthenium compound are superior from the viewpoint of having low electrical resistivity compared to tantalum, a tantalum alloy or a tantalum compound, being capable of forming a film according to a chemical vapor phase deposition (CVD) method, and being applicable to wiring of narrower widths. However, since noble metal materials such as ruthenium, a ruthenium alloy and a ruthenium compound are chemically stable and have high hardness as in the case of tantalum, a tantalum alloy or a tantalum compound, polishing is difficult.

Furthermore, noble metal materials are used as, for example, electrode materials for a production process for a DRAM capacitor structure. Then, polishing using a polishing composition has been utilized in order to eliminate portions of a part formed from a material including a noble metal such as simple ruthenium or ruthenium oxide (RuOx). However, similarly to the noble metal materials for barrier layers as described above, since it generally takes time to eliminate materials containing chemically stable noble metals, there is a strong demand for further improvements for increasing throughputs regarding polishing compositions of this kind.

A polishing agent used for CMP generally includes an oxidizing agent and abrasive grains. It is contemplated that the fundamental mechanism for CMP utilizing this CMP polishing agent involves, first, oxidizing the surface of a metal film by the oxidizing agent, and grinding off the oxidized layer on the metal film surface thus obtained, by means of abrasive grains. Since the oxidized layer on the metal film surface in concavities is not much brought into contact with a polishing pad and is not subjected to the effect of grinding off by abrasive grains, the metal film on convexities is removed along with the progress of CMP, and thus the substrate surface is flattened.

In regard to CMP, it is required to provide a high polishing speed for the wiring metal, stability of the polishing speed, and a low defect density at the polished surface. However, a film containing ruthenium is chemically stable and has high hardness compared to other damascene wiring metal films such as copper or tungsten, and therefore, it is difficult to polish a film containing ruthenium. As a polishing liquid for a film containing such a noble metal, particularly a film containing ruthenium, for example, JP 2004-172326 A suggests a polishing liquid containing polishing abrasive grains, an oxidizing agent, and benzotriazole.

Furthermore, as one of technologies for reducing the power consumption or enhancing performance (operation characteristics) in a transistor, an investigation has been conducted on channels which use a high mobility material that exhibits higher mobility of carriers than that of Si (hereinafter, also simply referred to as “high mobility material”). In channels that have been produced using such a high mobility material and thus have improved transport characteristics of carriers, the drain current can be increased in the ON-state. Therefore, the source voltage can be decreased while a sufficient on-current is obtained.

This combination brings about superior performance of a MOSFET (metal oxide semiconductor field-effect transistor) at lower electric power.

Regarding the high mobility material, application of Group III-V compounds, Group IV compounds, Ge (germanium) and graphene composed only of C (carbon), and the like has been anticipated. Particularly, application of Group III-V compounds containing As or Group IV compounds containing Ge has been considered positively.

Channels that use a high mobility material can be formed by polishing an object of polishing having a portion containing a high mobility material (hereinafter, also referred to as high mobility material portion) and a portion containing a silicon material (hereinafter, also referred to as silicon material portion). In this case, it is required to achieve processing of the high mobility material portion into a smooth surface by polishing the portion at a high polishing speed, as well as suppression of the generation of a level difference caused by etching, on the surface after polishing of the object of polishing. For example, JP 2006-278981A (corresponding to US 2006/0218867 A) discloses a polishing composition that is used for polishing a Ge substrate.

### SUMMARY OF INVENTION

However, the polishing composition described in JP 2006-278981 A (corresponding to US 2006/0218867 A) has a problem with a high rate of dissolution of Ge and generation of recesses.

Thus, an object of the present invention is to provide a polishing composition that is suitable for polishing an object of polishing having a layer containing a high mobility material that has higher carrier mobility than Si, suppresses excessive dissolution of the layer containing a high mobility material, and is capable of efficient polishing.

The inventors of the present invention repeatedly conducted a thorough investigation in order to solve the problem described above. As a result, the inventors found that the above-described problem can be solved by a polishing composition including abrasive grains and a salt having a particular structure. The inventors finally completed the present invention based on these findings.

That is, the present invention is a polishing composition used for polishing an object of polishing having a layer containing a high mobility material with higher carrier mobility than that of Si, the polishing composition including: abrasive grains; and at least one salt compound selected from the group consisting of a salt of a monovalent acid, a salt of a divalent acid, a salt of a trivalent acid, and a halide salt, wherein the polishing composition has an electrical conductivity of 1 mS/cm or higher, and a content of hydrogen peroxide of less than 0.1% by mass.

### DESCRIPTION OF EMBODIMENTS

According to the present invention, there is provided a polishing composition that is used for polishing an object of polishing having a layer containing a high mobility material that has higher carrier mobility than Si, the polishing composition including abrasive grains and at least one salt compound selected from a salt of a monovalent acid, a salt of a divalent acid, a salt of a trivalent acid, and a halide salt, in which the electrical conductivity is 1 mS/cm or higher, and a content of hydrogen peroxide is less than 0.1% by mass. When such a configuration is adopted, a polishing composition which is suitable for polishing an object of polishing having a layer containing a high mobility material, suppresses excessive dissolution of the layer containing a high mobility material, and can increase the polishing speed, is obtained.

The details on how the above-described effects may be obtained by the polishing composition of the present invention are not clearly understood; however, the following mechanism may be contemplated. That is, when a salt compound is included in a polishing composition, electrical conductivity of the polishing composition becomes high. As a result, it is speculated that the electric double layer formed on the surface of the layer containing a high mobility material is compressed, the action of the abrasive grains is enhanced, and the polishing speed for the layer containing a high mobility material is increased. Meanwhile, this mechanism is only based on speculations, and the present invention is not intended to be limited to the above-described mechanism.

[Object of Polishing]

The polishing composition according to the present invention is suitably used for an application of polishing an object of polishing having a layer containing a high mobility material. Further, the polishing composition is used for an application of polishing the object of polishing and producing a substrate. Preferred examples of the high mobility material as an object of polishing include Group IV compounds containing Ge, and Group III-V compounds containing As. More specifically, at least one selected from the group consisting of Ge (germanium), SiGe (silicon-germanium) having a content of Ge of 10% by mass or more, GaAs (gallium arsenide) having a content of As of 10% by mass or more, InAs (indium arsenide), AlAs (aluminum arsenide), InGaAs (indium gallium arsenide), InGaAsP (indium gallium arsenide phosphide), AlGaAs (aluminum gallium arsenide), and InAlGaAs (indium aluminum gallium arsenide) may be more preferably used.

The object of polishing according to the present invention may have a layer containing a silicon-containing material. Examples of the silicon-containing material include simple silicon substance and silicon compounds. Furthermore, examples of the simple silicon substance include single crystal silicon, polycrystalline silicon (poly-silicon, Poly-Si), and amorphous silicon. Examples of the silicon compounds include silicon nitride (SiN), silicon oxide, silicon carbide, and tetraethyl orthosilicate (TEOS). Examples of the layer containing a silicon-containing material also include a low relative permittivity film having a relative permittivity of 3 or less.

Among these silicon-containing materials, preferred examples include single crystal silicon, polycrystalline silicon, silicon nitride, silicon oxide, and tetraethyl orthosilicate.

Next, the configuration of the polishing composition of the present invention will be explained in detail.

[Abrasive Grains]

The polishing composition of the present invention includes abrasive grains. The abrasive grains have an effect of mechanically polishing an object of polishing, and increase the polishing speed of the polishing composition for an object of polishing.

The abrasive grains to be used may be any of inorganic particles, organic particles, and organic-inorganic composite particles. Specific examples of the inorganic particles include, for example, particles formed from metal oxides such as silica, alumina, ceria, and titania; silicon nitride particles, silicon carbide particles, and boron nitride particles. Specific examples of the organic particles include, for example, polymethyl methacrylate (PMMA) particles. The abrasive grains may be used singly or as mixtures of two or more kinds thereof. Also, regarding the abrasive grains, a commercially available product may be used, or a synthesized product may be used.

Among these abrasive grains, silica is preferred, and particularly preferred is colloidal silica.

In order to increase the polishing rate for a high mobility material, it is preferable to use surface-modified abrasive grains as the abrasive grains. Such surface-modified abrasive grains can be obtained by, for example, mixing a metal such as aluminum, titanium or zirconium, or an oxide of such a metal, with abrasive grains, and thereby doping the metal into the surface of the abrasive grains, or by immobilizing an organic acid.

Among surface-modified abrasive grains, particularly preferred is colloidal silica having an organic acid immobilized thereto. Immobilization of an organic acid onto the surface of colloidal silica included in a polishing composition is achieved as, for example, functional groups of the organic acid are chemically bonded to the surface of the colloidal silica. Immobilization of an organic acid onto colloidal silica is not accomplished simply by incorporating colloidal silica and an organic acid together. If sulfonic acid, which is a kind of organic acid, is to be immobilized to colloidal silica, this can be carried out by, for example, the method described in “Sulfonic acid-functionalized silica through quantitative oxidation of thiol groups”, Chem. Commun., 246-247 (2003). Specifically, a colloidal silica having sulfonic acid immobilized on the surface can be obtained by having a silane coupling agent having a thiol group, such as 3-mercaptopropyltrimethoxysilane, coupled to the colloidal silica, and then oxidizing the thiol group using hydrogen peroxide. Alternatively, if a carboxylic acid is to be immobilized to colloidal silica, this can be carried out by, for example, the method described in “Novel Silane Coupling Agents Containing a Photolabile 2-Nitrobenzyl Ester for Introduction of a Carboxy Group on the Surface of Silica Gel”, Chemistry Letters, 3, 228-229 (2000). Specifically, a colloidal silica having a carboxylic acid immobilized on the surface can be obtained by having a silane coupling agent containing a photoreactive 2-nitrobenzyl ester, coupled to the colloidal silica, and then irradiating the colloidal silica with light.

Furthermore, a cationic silica produced by adding a basic aluminum salt or a basic zirconium salt, which is disclosed in JP 4-214022 A, can also be used as abrasive grains.

The lower limit of the average primary particle size of the abrasive grains is preferably 5 nm or more, more preferably 7 nm or more, and even more preferably 10 nm or more. Furthermore, the upper limit of the average primary particle size of the abrasive grains is preferably 200 nm or less, more preferably 150 nm or less, and even more preferably 100 nm or less. When the average primary particle size is in such a range, an object of polishing can be efficiently polished. Furthermore, dishing occurring on the surface of an object of polishing after being polished using the polishing composition can be further suppressed. The average primary particle size of the abrasive grains is calculated, for example, based on the specific surface area of the abrasive grains as measured by the BET method.

The lower limit of the average secondary particle size of the abrasive grains is preferably 30 nm or more, more preferably 35 nm or more, and even more preferably 40 nm or more. Furthermore, the upper limit of the average secondary particle size of the abrasive grains is preferably 300 nm or less, more preferably 260 nm or less, and even more preferably 220 nm or less. When the average secondary particle size is in such a range, an object of polishing can be efficiently polished. Furthermore, surface defects occurring on the surface of an object of polishing after being polished using the polishing composition can be further suppressed. Meanwhile, the secondary particles as used herein refer to particles that are formed when abrasive grains are associated within the polishing composition, and this average secondary particle size of the abrasive grains can be measured by, for example, a dynamic light scattering method.

The lower limit of the content of the abrasive grains in the polishing composition is preferably 0.005% by mass or more, more preferably 0.05% by mass or more, and even more preferably 0.1% by mass or more. As the content of the abrasive grains becomes larger, the polishing speed for an object of polishing is increased. Furthermore, the upper limit of the content of the abrasive grains in the polishing composition is preferably 50% by mass or less, more preferably 30% by mass or less, and even more preferably 20% by mass or less. When the content of the abrasive grains is in such a range, the cost of the polishing composition can be lowered, and the occurrence of surface defects on the surface of the object of polishing after being polished using the polishing composition can be further suppressed.

[Salt Compound]

The salt compound used for the present invention is at least one compound selected from the group consisting of a salt of a monovalent acid, a salt of a divalent acid, a salt of a trivalent acid, and a halide salt. Such a salt compound increases the electrical conductivity of the polishing composition, and compresses the electric double layer on the surface of an object of polishing having a layer containing a high mobility material. Accordingly, the action of the abrasive grains is enhanced, and the polishing speed for the layer containing a high mobility material is increased.

Examples of the monovalent acid include inorganic acids such as hydrochloric acid, nitric acid, and nitrous acid; and organic acids such as formic acid, acetic acid, lactic acid, propionic acid, acrylic acid, methacrylic acid, capric acid, caprylic acid, caproic acid, glyoxylic acid, crotonic acid, benzoic acid, and methanesulfonic acid. Examples of the divalent acid include inorganic acids such as sulfuric acid, carbonic acid, sulfurous acid, thiosulfuric acid, and phosphonic acid; and organic acids such as oxalic acid, malic acid, malonic acid, maleic acid, fumaric acid, glutaric acid, adipic acid, succinic acid, sebacic acid, and tartaric acid. Examples of the trivalent acid include inorganic acids such as phosphoric acid, phosphomolybdic acid, phosphotungstic acid, and vanadic acid; and organic acids such as citric acid and trimellitic acid.

Examples of the salt of a monovalent acid, the salt of a divalent acid, and the salt of a trivalent acid include inorganic salts such as a lithium salt, a sodium salt, a potassium salt, a calcium salt, and a magnesium salt; and organic salts such as an ammonium salt, a triethylamine salt, a diisopropylamine salt, and a cyclohexylamine salt. Examples of the halide salt include a fluoride salt, a chloride salt, a bromide salt, and an iodide salt.

More specific examples of the salt compound include sodium nitrate, potassium nitrate, ammonium nitrate, magnesium nitrate, calcium nitrate, sodium nitrite, potassium nitrite, lithium acetate, sodium acetate, potassium acetate, ammonium acetate, calcium acetate, calcium lactate, lithium benzoate, sodium benzoate, potassium benzoate, lithium carbonate, sodium carbonate, potassium carbonate, magnesium carbonate, calcium carbonate, lithium hydrogen carbonate, sodium hydrogen carbonate, potassium hydrogen carbonate, ammonium carbonate, sodium bicarbonate, sodium sulfate, potassium sulfate, ammonium sulfate, calcium sulfate, magnesium sulfate, sodium sulfite, potassium sulfite, calcium sulfite, magnesium sulfite, potassium thiosulfate, lithium sulfate, magnesium sulfate, sodium thiosulfate, sodium hydrogen sulfite, sodium hydrogen sulfate, potassium hydrogen sulfate, disodium oxalate, dipotassium oxalate, diammonium oxalate, triammonium citrate, disodium glutarate, lithium fluoride, sodium fluoride, potassium fluoride, calcium fluoride, ammonium fluoride, potassium chloride, sodium chloride, ammonium chloride, calcium chloride, potassium bromide, sodium bromide, ammonium bromide, calcium bromide, sodium iodide, potassium iodide, potassium triiodide, calcium iodide, trilithium phosphate, tripotassium phosphate, trisodium phosphate, triammonium phosphate, sodium monohydrogen phosphate, potassium monohydrogen phosphate, sodium dihydrogen phosphate, potassium dihydrogen phosphate, and ammonium dihydrogen phosphate.

Among these, from the viewpoint of handleability, potassium acetate, potassium nitrate, ammonium nitrate, potassium hydrogen carbonate, ammonium sulfate, potassium chloride, sodium chloride, potassium bromide, potassium iodide, and triammonium citrate are preferred.

The lower limit of the content of the salt compound in the polishing composition of the present invention is preferably 0.001 mol/L or more, more preferably 0.005 mol/L or more, and even more preferably 0.01 mol/L or more. As the content of the salt compound becomes larger, an object of polishing can be efficiently polished. Furthermore, the upper limit of the content of the salt compound in the polishing composition of the present invention is preferably 2.0 mol/L or less, more preferably 1.0 mol/L or less, and even more preferably 0.5 mol/L or less. As the content of the salt compound becomes smaller, storage stability can be enhanced.

[Electrical Conductivity]

The electrical conductivity of the polishing composition of the present invention is 1 mS/cm or higher. In a case in which the electrical conductivity is lower than 1 mS/cm, the electric double layer at the surface of an object of polishing having a layer containing a high mobility material is not compressed, and an effect of increasing the polishing speed for a layer containing a high mobility material cannot be obtained. The electrical conductivity is 1 mS/cm or higher, and the electrical conductivity is preferably 1.1 mS/cm or higher, more preferably 5 mS/cm or higher, and even more preferably 9 mS/cm or higher. The upper limit of the electrical conductivity is not particularly limited; however, the upper limit is preferably 40 mS/cm or lower, and more preferably 30 mS/cm or lower.

Specifically, the electrical conductivity can be measured by the method described in Examples. Also, the electrical conductivity can be controlled by the type and amount of addition of the salt compound, and the like.

[Hydrogen Peroxide]

The content of hydrogen peroxide in the polishing composition of the present invention is less than 0.1% by mass. In a case in which the content of hydrogen peroxide is 0.1% by mass or more, the rate of dissolution of the high mobility material becomes faster, and defects occur on the surface of the layer containing a high mobility material. The content of hydrogen peroxide is preferably 0.05% by mass or less, and more preferably 0.03% by mass or less, and it is even more preferable that the polishing composition does not include hydrogen peroxide (the content is zero).

[pH of Polishing Composition]

The pH of the polishing composition of the present invention is preferably 2 or higher, more preferably 2.2 or higher, and even more preferably 2.5 or higher. Furthermore, the pH of the polishing composition of the present invention is preferably below 14, more preferably 13 or lower, and even more preferably 12 or lower. When the pH is in this range, an object of polishing can be efficiently polished.

The pH can be adjusted by adding an appropriate amount of a pH adjusting agent. The pH adjusting agent that is used as necessary in order to adjust the pH of the polishing composition to a desired value, may be any of an acid or an alkali, and may be any one of inorganic and organic compounds. Specific examples of the pH adjusting agent include, for example, inorganic acids such as sulfuric acid, nitric acid, boric acid, carbonic acid, hypophosphorous acid, phosphorous acid, and phosphoric acid; and organic acids, including carboxylic acids such as formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citric acid and lactic acid, and organic sulfuric acids such as methanesulfonic acid, ethanesulfonic acid and isethionic acid. These pH regulating agents may be used singly or as mixtures of two or more kinds thereof.

[Dispersing Medium or Solvent]

In the polishing composition of the present invention, a dispersing medium or solvent intended for dispersing or dissolving various components is usually used. Examples of the dispersing medium or solvent include organic solvents and water; however, among them, it is preferable that the dispersing medium or solvent includes water. From the viewpoint of inhibiting the action of other components, water that does not contain impurities as far as possible is preferred. Specifically, pure water from which impurity ions have been removed using an ion exchange resin and then foreign materials have been removed through a filter, ultrapure water, or distilled water is preferred.

[Other Components]

The polishing composition of the present invention may further include other components such as an oxidizing agent containing a halogen atom, a complexing agent, a metal anticorrosive, a surfactant, a water-soluble polymer, an antiseptic agent, and an antifungal agent. In the following description, those other components will be explained.

[Oxidizing Agent Containing Halogen Atom]

It is preferable that the polishing composition of the present invention includes an oxidizing agent containing a halogen atom. When the polishing composition includes an oxidizing agent containing a halogen atom, the polishing speed for a layer containing a high mobility material is further increased.

Specific examples of the oxidizing agent containing a halogen atom include, for example, halogenous acids and salts thereof, such as chlorous acid (HClO₂), bromous acid (HBrO₂), iodous acid (HIO₂), sodium chlorite (NaClO₂), potassium chlorite (KClO₂), sodium bromite (NaBrO₂), and potassium bromite (KBrO₂); halogenic acids and salts thereof, such as chloric acid (HClO₃), bromic acid (HBrO₃), iodic acid (HIO₃), sodium chlorate (NaClO₃), potassium chlorate (KClO₃), silver chlorate (AgClO₃), barium chlorate (Ba(ClO₃)₂), sodium bromate (NaBrO₃), potassium bromate (KBrO₃), and sodium iodate (NaIO₃); perhalogenic acids and salts thereof, such as perchloric acid (HClO₄), perbromic acid (HBrO₄), periodic acid (HIO₄), sodium periodate (NaIO₄), potassium periodate (KIO₄), and tetrabutylammonium periodate ((C₄H₉)₄NIO₄); hypohalogenous acids such as hypofluorous acid (HFO), hypochlorous acid (HClO), hypobromous acid (HBrO), and hypoiodous acid (HIO); salts of hypofluorous acid, such as lithium hypofluorite (LiFO), sodium hypofluorite (NaFO), potassium hypofluorite (KFO), magnesium hypofluorite (Mg(FO)₂), calcium hypofluorite (Ca(FO)₂), and barium hypofluorite (Ba(FO)₂); salts of hypochlorous acid, lithium hypochlorite (LiClO), sodium hypochlorite (NaClO), potassium hypochlorite (KClO), magnesium hypochlorite (Mg(ClO)₂), calcium hypochlorite (Ca(ClO)₂), barium hypochlorite (Ba(ClO)₂), t-butyl hypochlorite (t-BuClO) ammonium hypochlorite (NH₄ClO), and triethanolamine hypochlorite ((CH₂CH₂OH)₃N.ClO); salts of hypobromous acid, such as lithium hypobromite (LiBrO), sodium hypobromite (NaBrO), potassium hypobromite (KBrO), magnesium hypobromite (Mg(BrO)₂), calcium hypobromite (Ca(BrO)₂) barium hypobromite (Ba(BrO)₂), ammonium hypobromite (NH₄BrO), and triethanolamine hypobromite ((CH₂CH₂OH)₃N.BrO); and salts of hypoiodous acid, such as lithium hypoiodite (LiIO), sodium hypoiodite (NaIO), potassium hypoiodite (KIO), magnesium hypoiodite (Mg(IO)₂), calcium hypoiodite (Ca(IO)₂), barium hypoiodite (Ba(IO)₂), ammonium hypoiodite (NH₄IO), and triethanolamine hypoiodite ((CH₂CH₂OH)₃N.IO). These oxidizing agents containing a halogen atom may be used singly or as mixtures of two or more kinds thereof.

Among these oxidizing agents having a halogen atom, chlorous acid, hypochlorous acid, chloric acid, perchloric acid, and salts thereof are preferred. Regarding the salts, ammonium salts, sodium salts, potassium salts and the like can be selected.

The lower limit of the content of the oxidizing agent containing a halogen atom in the polishing composition of the present invention is preferably 0.01% by mass (0.1 g/kg) or more, and more preferably 0.05% by mass (0.5 g/kg) or more. As the content of the oxidizing agent containing a halogen atom becomes larger, the polishing speed generated by the polishing composition is increased. Furthermore, the upper limit of the content of the oxidizing agent containing a halogen atom in the polishing composition of the present invention is preferably 10% by mass or less (100 g/kg), and more preferably 5% by mass (50 g/kg) or less. As the content of the oxidizing agent containing a halogen atom becomes smaller, the cost of the polishing composition can be lowered, and in addition, there is an advantage that the burden for a treatment of the polishing composition after use in polishing, that is, the burden for a waste water treatment, can be reduced. There is also an advantage that excessive oxidation of the surface of an object of polishing caused by the oxidizing agent containing a halogen atom cannot easily occur.

[Metal Anticorrosive]

When a metal anticorrosive is added to the polishing composition, dissolution of metal can be prevented and deterioration of the surface state such as surface roughness of the surface of an object of polishing can be suppressed.

The metal anticorrosive that can be used is not particularly limited; however, a heterocyclic compound is preferred. The number of member atoms of the heterocyclic ring in the heterocyclic compound is not particularly limited. The heterocyclic compound may be a monocyclic compound, or may be a polycyclic compound having a fused ring. The metal anticorrosive may be used singly, or as mixtures of two or more kinds thereof. Furthermore, regarding the metal anticorrosive, a commercially available product may be used, or a synthesized product may be used.

Specific examples of the heterocyclic compound that can be used as a metal anticorrosive include, for example, nitrogen-containing heterocyclic compounds such as a pyrrole compound, a pyrazole compound, an imidazole compound, a triazole compound, a tetrazole compound, a pyridine compound, a pyrazine compound, a pyridazine compound, a pyrindine compound, an indolizine compound, an indole compound, an isoindole compound, an indazole compound, a purine compound, a quinolidine compound, a quinoline compound, an isoquinoline compound, a naphthyridine compound, a phthalazine compound, a quinoxaline compound, a quinazoline compound, a cinnoline compound, a pteridine compound, a thiazole compound, an isothiazole compound, an oxazole compound, an isoxazole compound, and a furazan compound.

More specific examples include, as examples of the pyrazole compound, for example, 1H-pyrazole, 4-nitro-3-pyrazolecarboxylic acid, 3,5-pyrazolecarboxylic acid, 3-amino-5-phenylpyrazole, 5-amino-3-phenylpyrazole, 3,4,5-tribromopyrazole, 3-aminopyrazole, 3,5-dimethylpyrazole, 3,5-dimethyl-1-hydroxymethylpyrazole, 3-methylpyrazole, 1-methylpyrazole, 3-amino-5-methylpyrazole, 4-aminopyrazolo[3,4-d]pyrimidine, allopurinol, 4-chloro-1H-pyrazolo[3,4-D]pyrimidine, 3,4-dihydroxy-6-methylpyrazolo(3,4-B)pyridine, and 6-methyl-1H-pyrazolo[3,4-b]pyridin-3-amine.

Examples of the imidazole compound include, for example, imidazole, 1-methylimidazole, 2-methylimidazole, 4-methylimidazole, 1,2-dimethylpyrazole, 2-ethyl-4-methylimidazole, 2-isopropylimidazole, benzimidazole, 5,6-dimethylbenzimidazole, 2-aminobenzimidazole, 2-chlorobenzimidazole, 2-methylbenzimidazole, 2-(1-hydroxyethyl)benzimidazole, 2-hydroxybenzimidazole, 2-phenylbenzimidazole, 2,5-dimethylbenzimidazole, 5-methylbenzimidazole, 5-nitrobenzimidazole, and 1H-purine.

Examples of the triazole compound include, for example, 1,2,3-triazole, 1,2,4-triazole, 1-methyl-1,2,4-triazole, methyl-1H-1,2,4-triazole-3-carboxylate, 1,2,4-triazole-3-carboxylic acid, methyl 1,2,4-triazole-3-carboxylate, 1H-1,2,4-triazole-3-thiol, 3,5-diamino-1H-1,2,4-triazole, 3-amino-1,2,4-triazole-5-thiol, 3-amino-1H-1,2,4-triazole, 3-amino-5-benzyl-4H-1,2,4-triazole, 3-amino-5-methyl-4H-1,2,4-triazole, 3-nitro-1,2,4-triazole, 3-bromo-5-nitro-1,2,4-triazole, 4-(1,2,4-triazol-1-yl)phenol, 4-amino-1,2,4-triazole, 4-amino-3,5-dipropyl-4H-1,2,4-triazole, 4-amino-3,5-dimethyl-4H-1,2,4-triazole, 4-amino-3,5-dipeptyl-4H-1,2,4-triazole, 5-methyl-1,2,4-triazole-3,4-diamine, 1H-benzotriazole, 1-hydroxybenzotriazole, 1-aminobenzotriazole, 1-carboxybenzotriazole, 5-chloro-1H-benzotriazole, 5-nitro-1H-benzotriazole, 5-carboxy-1H-benzotriazole, 5-methyl-1H-benzotriazole, 5,6-dimethyl-1H-benzotriazole, 1-(1′,2′-dicarboxyethyl)benzotriazole, 1-[N,N-bis(hydroxyethyl)aminomethyl]benzotriazole, 1-[N,N-bis(hydroxyethyl)aminomethyl]-5-methylbenzotriazole, and 1-[N,N-bis(hydroxyethyl)aminomethyl]-4-methylbenzotriazole.

Examples of the tetrazole compound include, for example, 1H-tetrazole, 5-methyltetrazole, 5-aminotetrazole, and 5-phenyltetrazole.

Examples of the indazole compound include, for example, 1H-indazole, 5-amino-1H-indazole, 5-nitro-1H-indazole, 5-hydroxy-1H-indazole, 6-amino-1H-indazole, 6-nitro-1H-indazole, 6-hydroxy-1H-indazole, and 3-carboxy-5-methyl-1H-indazole.

Examples of the indole compound include 1H-indole, 1-methyl-1H-indole, 2-methyl-1H-indole, 3-methyl-1H-indole, 4-methyl-1H-indole, 5-methyl-1H-indole, 6-methyl-1H-indole, 7-methyl-1H-indole, 4-amino-1H-indole, 5-amino-1H-indole, 6-amino-1H-indole, 7-amino-1H-indole, 4-hydroxy-1H-indole, 5-hydroxy-1H-indole, 6-hydroxy-1H-indole, 7-hydroxy-1H-indole, 4-methoxy-1H-indole, 5-methoxy-1H-indole, 6-methoxy-1H-indole, 7-methoxy-1H-indole, 4-chloro-1H-indole, 5-chloro-1H-indole, 6-chloro-1H-indole, 7-chloro-1H-indole, 4-carboxy-1H-indole, 5-carboxy-1H-indole, 6-carboxy-1H-indole, 7-carboxy-1H-indole, 4-nitro-1H-indole, 5-nitro-1H-indole, 6-nitro-1H-indole, 7-nitro-1H-indole, 4-nitrile-1H-indole, 5-nitrile-1H-indole, 6-nitrile-1H-indole, 7-nitrile-1H-indole, 2,5-dimethyl-1H-indole, 1,2-dimethyl-1H-indole, 1,3-dimethyl-1H-indole, 2,3-dimethyl-1H-indole, 5-amino-2,3-dimethyl-1H-indole, 7-ethyl-1H-indole, 5-(aminomethyl)indole, 2-methyl-5-amino-1H-indole, 3-hydroxymethyl-1H-indole, 6-isopropyl-1H-indole, and 5-chloro-2-methyl-1H-indole.

Among these, a preferred heterocyclic compound is a triazole compound, and particularly, 1H-benzotriazole, 5-methyl-1H-benzotriazole, 5,6-dimethyl-1H-benzotriazole, 1-[N,N-bis(hydroxyethyl)aminomethyl)-5-methylbenzotriazole, 1-[N,N-bis(hydroxyethyl)aminomethyl]-4-methylbenzotriazole, 1,2,3-triazole, and 1,2,4-triazole are preferred. Since these heterocyclic compounds have high chemical or physical adsorptive power toward the surface of an object of polishing, the heterocyclic compounds can form a stronger protective film on the surface of an object of polishing. This is advantageous for enhancing the flatness of the surface of an object of polishing after the surface is polished using the polishing composition of the present invention.

The lower limit of the content of the metal anticorrosive in the polishing composition is preferably 0.001 g/L or more, and more preferably 0.005 g/L or more. As the content of the metal anticorrosive becomes larger, dissolution of metal is prevented and the level difference elimination performance can be enhanced. Furthermore, the upper limit of the content of the metal anticorrosive in the polishing composition is preferably 10 g/L or less, and more preferably 5 g/L or less. As the content of the metal anticorrosive becomes smaller, the polishing speed is increased.

[Surfactant]

The polishing composition may include a surfactant. A surfactant can improve the cleaning efficiency after polishing by imparting hydrophilicity to a polished surface after polishing, and can prevent attachment of contaminants. The surfactant may be any of an anionic surfactant, a cationic surfactant, an amphoteric surfactant, and a nonionic surfactant. These surfactants may be used singly, or as mixtures of two or more kinds thereof.

Examples of the anionic surfactant include, for example, a polyoxyethylene alkyl ether acetic acid, a polyoxyethylene alkyl sulfuric acid ester, an alkyl sulfuric acid ester, a polyoxyethylene alkyl ether sulfuric acid, an alkyl ether sulfuric acid, an alkyl benzenesulfonic acid, an alkyl phosphoric acid ester, a polyoxyethylene alkyl phosphoric acid ester, a polyoxyethylene sulfosuccinic acid, an alkyl sulfosuccinic acid, an alkyl naphthalenesulfonic acid, an alkyl diphenyl ether disulfonic acid, and salts thereof.

Examples of the cationic surfactant include, for example, an alkyltrimethylammonium salt, an alkyldimethylammonium salt, an alkylbenzyldimethylammonium salt, and an alkylamine salt.

Examples of the amphoteric surfactant include, for example, an alkylbetaine and an alkylamine oxide. Examples of the nonionic surfactant include, for example, a polyoxyethylene alkyl ether, a polyoxyalkylene alkyl ether, a sorbitan fatty acid ester, a glycerin fatty acid ester, a polyoxyethylene fatty acid ester, a polyoxyethylene alkylamine, and an alkylalkanol amide.

The content of the surfactant in the polishing composition is preferably 0.0001 g/L or more, and more preferably 0.001 g/L or more. As the content of the surfactant becomes larger, the cleaning efficiency after polishing is further increased. Furthermore, the content of the surfactant in the polishing composition is preferably 10 g/L or less, and more preferably 1 g/L or less. As the content of the surfactant becomes smaller, the residual amount of the surfactant on a polished surface is reduced, and the cleaning efficiency is further increased.

[Water-Soluble Polymer]

The polishing composition may also include a water-soluble polymer. Specific examples of the water-soluble polymer include, for example, a polystyrene sulfonic acid salt, a polyisoprene sulfonic acid salt, a polyacrylic acid salt, polymaleic acid, polyitaconic acid, polyvinyl acetate, polyvinyl alcohol, polyglycerin, polyvinylpyrrolidone (PVP), a copolymer of isoprenesulfonic acid and acrylic acid, a polyvinylpyrrolidone-polyacrylic acid copolymer, a polyvinylpyrrolidone-vinyl acetate copolymer, a salt of naphthalenesulfonic acid-formalin condensate, a diallylamine hydrochloride-sulfur dioxide copolymer, carboxymethyl cellulose, a salt of carboxymethyl cellulose, hydroxyethyl cellulose, hydroxypropyl cellulose, pullulan, chitosan, and chitosan salts.

In a case in which a water-soluble polymer is added to the polishing composition, surface roughness of an object of polishing after being polished using the polishing composition is further decreased. These water-soluble polymers may be used singly or as mixtures of two or more kinds thereof.

Furthermore, the water-soluble polymers described above have a function as polish inhibitors particularly for Poly-Si.

The content of the water-soluble polymer in the polishing composition is preferably 0.0001 g/L or more, and preferably 0.001 g/L or more. As the content of the water-soluble polymer becomes larger, surface roughness of a polished surface polished by the polishing composition is further decreased. Also, the content of the water-soluble polymer in the polishing composition is preferably 10 g/L or less, and more preferably 1 g/L or less. As the content of the water-soluble polymer becomes smaller, the residual amount of the water-soluble polymer on a polished surface is reduced, and the cleaning efficiency is further increased.

[Antiseptic Agent and Antifungal Agent]

Examples of the antiseptic agent and antifungal agent that are used for the present invention include isothiazoline-based antiseptic agents such as 2-methyl-4-isothiazolin-3-one and 5-chloro-2-methyl-4-isothiazolin-3-one; para-oxybenzoic acid esters; and phenoxyethanol. These antiseptic agents and antifungal agents may be used singly, or as mixtures of two or more kinds thereof.

[Method for Producing Polishing Composition]

The method for producing the polishing composition of the present invention is not particularly limited, and the polishing composition can be obtained by, for example, mixing with stirring abrasive grains, at least one salt compound selected from the group consisting of a salt of a monobasic acid, a salt of a dibasic acid, a salt of a tribasic aid, and a halide salt, and other components as necessary, in water.

The temperature employed at the time of mixing the various components is not particularly limited; however, the temperature is preferably 10° C. to 40° C., and the components may also be heated in order to increase the rate of dissolution. The mixing time is also not particularly limited.

[Polishing Method and Method for Producing Substrate]

As explained above, the polishing composition of the present invention is suitably used particularly for polishing an object of polishing having a layer containing a high mobility material. Therefore, the present invention provides a polishing method of polishing an object of polishing having a layer containing a high mobility material using the polishing composition of the present invention.

Regarding the polishing apparatus, a general polishing apparatus which is equipped with a holder for retaining a substrate or the like having an object of polishing; and a motor or the like capable of varying the number of rotations, and has a polishing table to which a polishing pad (polishing cloth) can be attached, can be used.

Regarding the polishing pad, a general nonwoven fabric, a polyurethane polishing pad, a porous fluororesin and the like can be used without any particular limitations. It is preferable that the polishing pad is subjected to grooving for the retention of polishing liquid.

There are no particular limitations on the conditions of polishing, and for example, the speed of rotation of the polishing table and the number of carrier rotations are each independently preferably 10 to 500 rpm, and the pressure applied to the substrate having an object of polishing (polishing pressure) is preferably 0.5 to 10 psi. The method for supplying the polishing composition to the polishing pad is also not particularly limited, and for example, a method of continuously supplying the polishing composition with a pump or the like is employed. The amount of supply of this polishing composition is not limited; however, it is preferable that the surface of the polishing pad is covered with the polishing composition of the present invention all the time.

After completion of polishing, the substrate is washed with flowing water, and is dried by dropping the water droplets adhering onto the substrate, by means of a spin drier or the like. Thus, a substrate having a layer containing a high mobility material is obtained.

### EXAMPLES

The present invention will be described in more detail using the following Examples and Comparative Examples. However, the technical scope of the present invention is not intended to be limited to the following Examples only.

### Examples 1 to 57 and Comparative Examples 1 to 18

The abrasive grains and the salt compounds indicated in the following Tables 2-1 to 2-4 were incorporated so as to obtain the contents indicated in the following Table 2 with respect to the total amount of the polishing composition. Furthermore, an aqueous solution of sodium hypochlorite (concentration: 5.9% by mass) or an aqueous solution of hydrogen peroxide (concentration: 31% by mass) was prepared as an oxidizing agent, and these components were mixed with stirring in water (mixing temperature: about 25° C., mixing time: about 10 minutes), so as to obtain the contents indicated in the following Tables 2-1 to 2-4 with respect to the total amount of the polishing composition. Thus, polishing compositions of Examples 1 to 57 and Comparative Examples 1 to 18 were produced. The pH of the polishing composition was adjusted by adding potassium hydroxide (KOH) thereto, and the pH was checked using a pH meter.

Regarding the abrasive grains, the following materials were used, and the content of the abrasive grains in the polishing composition was adjusted to 1% by mass.

A: Colloidal silica having an average primary particle size of 32 nm and an average secondary particle size of 70 nm.

B: Silica having sulfonic acid immobilized onto the surface (having an average primary particle size of 32 nm and an average secondary particle size of 70 nm)

C: Silica having the surface modified with aluminum (having an average primary particle size of 32 nm and an average secondary particle size of 70 nm)

[Electrical Conductivity]

The electrical conductivity of the polishing composition was measured using an electrical conductivity meter manufactured by Horiba, Ltd.

[Polishing Speed]

With regard to a Ge substrate, a SiGe substrate (Si:Ge=50:50), a GaAs substrate, an InGaAs substrate (In:Ga:As=26.5:23.5:50.0), a TEOS substrate, and a SiN substrate, the polishing speed obtainable when each of the substrates was polished for a certain time under the conditions of polishing indicated in the following Table 1 using each of the polishing compositions of Examples 1 to 37 and Comparative Examples 1 to 14, was determined. Regarding the Ge substrate, a 4-inch Ge substrate was used after being processed into 30□ coupons. The TEOS substrate was used after being processed into 30□ coupons. The SiN substrate was used after being processed into 30□ coupons.

In regard to the polishing compositions of Examples 38 to 57 and Comparative Examples 15 to 17, the polishing speeds and the rates of dissolution obtainable when a Ge substrate and an InGaAs substrate (In:Ga:As=26.5:23.5:50.0) were polished under the polishing conditions indicated in the following Table 1, and the surface roughness of the substrates after polishing were determined. Furthermore, in regard to the polishing compositions of Comparative Example 18 and Example 41, the polishing speeds and the rates of dissolution obtainable when a SiGe substrate (Si:Ge=50:50), a SiGe substrate (Si:Ge=15:85) and a GaAs substrate were polished, and the surface roughness of the substrates after polishing were determined.

The polishing speeds for the Ge substrate, TEOS substrate and SiN substrate were determined from the difference between the weights measured before and after polishing. In regard to the SiGe substrate (Si:Ge=50:50), SiGe substrate (Si:Ge=15:85), GaAs substrate, and InGaAs substrate (In:Ga:As=26.5:23.5:50.0), the polishing speeds were determined from the difference between the film thicknesses measured before and after polishing by XRF (X-ray Fluorescence).

TABLE 1
<Polishing conditions>

Polishing apparatus: Single-sided CMP polishing machine
(manufactured by Engis Japan Corporation)
Polishing pad: Polyurethane pad IC-1010
Polishing pressure: 1.5 psi (about 10.3 kPa)
Number of rotations of polishing table: 60 rpm
Number of carrier rotations: 40 rpm
Flow rate of polishing composition: 100 ml/min
Polishing time: 300 sec

[Rate of Dissolution]

Regarding the rate of dissolution for the Ge substrate, a Ge substrate having a size of 3 cm×3 cm was immersed for 5 minutes at 43° C. in a polishing composition that was rotated at 300 rpm using a stirring bar, the dissolved amount was calculated from the change in weight obtained before and after immersion, and the rate of dissolution for the Ge substrate was measured by dividing the dissolved amount by the immersion time and the specific gravity of Ge. In regard to the SiGe substrate (Si:Ge=50:50), SiGe substrate (Si:Ge=15:85), GaAs substrate, and InGaAs substrate (In:Ga:As=26.5:23.5:50.0), each substrate having a size of 3 cm×3 cm was immersed for 5 minutes at 43° C. in a polishing composition that was rotated at 300 rpm using a stirring bar, and then the rate of dissolution was measured by determining the difference between the film thicknesses obtained before and after dissolution, by XRF (X-ray Fluorescence).

[Stability]

An evaluation of stability of the polishing compositions of Examples 1 to 37 and Comparative Examples 1 to 14 was carried out as follows. That is, based on the polishing speed and the rate of dissolution for a Ge substrate generated by a polishing composition as measured on the day of preparation of the polishing composition, the change ratios of the polishing speed and the rate of dissolution for a Ge substrate obtained by using the polishing composition that had been stored for one week at 80° C. after preparation, were investigated. When the change ratios of the polishing speed for the Ge substrate and the rate of dissolution of the Ge substrate were 10% or less, it was rated as OK, and when at least one of the change ratios of the polishing speed for the Ge substrate and the rate of dissolution of the Ge substrate was more than 10%, it was rated as NG.

[Surface Roughness]

Surface roughness was measured using a substrate having a size of 3 cm×3 cm and using a SPM (scanning probe microscopy) apparatus Navi II (manufactured by SII Nanotechnology, Inc.). A silicon probe (product No.: SI-DF40P2) was used.

Formulations and evaluation results for the polishing compositions of Examples 1 to 57 and Comparative Examples 1 to 18 are shown in the following Tables 2-1 to 2-4. Meanwhile, the column for “Polishing speed/rate of dissolution” for the Ge substrate shows values obtained by dividing the polishing speed for the Ge substrate by the rate of dissolution of the Ge substrate. It is implied that as this value is larger, dissolution of the layer containing Ge is further suppressed, while the polishing speed for the layer containing Ge is further increased. The blank columns for the TEOS polishing speed and the SiN polishing speed show that the values were not measured.

TABLE 2-1

| | | | | | | | | Ge | | |
|---|---|---|---|---|---|---|---|---|---|---|
| | Abra- | | | | | | | | | Polishing |
| | sive | Oxidizing agent | | Salt compound | | | Electrical | Polishing | Rate of | speed/rate |
| | grains | | Concentration | | Concentration | | conductivity | speed | dissolution | of |
| | Type | Type | (mass %) | Type | (mol/L) | pH | (mS/cm) | (Å/min) | (Å/min) | dissolution |
| Example 1 | A | — | — | KNO₃ | 0.01 | 7.0 | 1.3 | 143 | 16 | 9 |
| Example 2 | A | — | — | KNO₃ | 0.05 | 7.0 | 5.0 | 205 | 17 | 12 |
| Example 3 | A | — | — | KNO₃ | 0.1 | 7.0 | 11.3 | 285 | 22 | 13 |
| Example 4 | A | — | — | KNO₃ | 0.2 | 7.0 | 20.6 | 342 | 25 | 14 |
| Example 5 | A | — | — | KNO₃ | 0.1 | 10.5 | 12.0 | 312 | 20 | 16 |
| Example 6 | A | — | — | KNO₃ | 0.1 | 9.0 | 11.3 | 293 | 22 | 13 |
| Example 7 | A | — | — | KNO₃ | 0.1 | 7.2 | 10.3 | 285 | 20 | 14 |
| Example 8 | A | — | — | KNO₃ | 0.1 | 6.5 | 10.1 | 290 | 20 | 14 |
| Example 9 | A | — | — | KNO₃ | 0.1 | 5.2 | 11.3 | 353 | 19 | 19 |
| Example 10 | A | — | — | KNO₃ | 0.1 | 4.1 | 11.3 | 352 | 18 | 20 |
| Example 11 | A | — | — | KNO₃ | 0.1 | 3.0 | 12.0 | 341 | 18 | 19 |
| Example 12 | B | — | — | KNO₃ | 0.1 | 7.0 | 11.3 | 336 | 21 | 16 |
| Example 13 | A | — | — | KNO₃ | 0.1 | 7.0 | 13.5 | 240 | 21 | 11 |
| Example 14 | A | — | — | KHCO₃ | 0.1 | 7.2 | 9.1 | 202 | 18 | 11 |
| Example 15 | A | — | — | KCl | 0.1 | 7.0 | 12.0 | 268 | 19 | 14 |
| Example 16 | A | — | — | KBr | 0.1 | 7.2 | 12.5 | 203 | 20 | 10 |
| Example 17 | A | — | — | KI | 0.1 | 7.1 | 12.4 | 329 | 23 | 14 |
| Example 18 | A | — | — | NaCl | 0.1 | 7.0 | 10.0 | 226 | 20 | 11 |
| Example 19 | A | — | — | (NH₄)₂SO₄ | 0.1 | 6.7 | 28.0 | 339 | 27 | 13 |
| Example 20 | A | — | — | NH₄NO₃ | 0.1 | 6.6 | 11.5 | 241 | 13 | 19 |
| Example 21 | A | NaClO | 1.0 | KNO₃ | 0.01 | 7.0 | 1.3 | 317 | 48 | 7 |
| Example 22 | A | NaClO | 1.0 | KNO₃ | 0.05 | 7.0 | 5.0 | 456 | 56 | 8 |
| Example 23 | A | NaClO | 1.0 | KNO₃ | 0.1 | 7.0 | 11.3 | 634 | 49 | 13 |
| Example 24 | A | NaClO | 1.0 | KNO₃ | 0.2 | 7.0 | 20.6 | 761 | 44 | 17 |
| Example 25 | A | NaClO | 1.0 | KNO₃ | 0.5 | 7.0 | 44.0 | 773 | 48 | 16 |
| Example 26 | B | NaClO | 1.0 | KNO₃ | 0.1 | 7.0 | 11.3 | 729 | 48 | 15 |

| | SiGe (Si:Ge = 50:50) | | GaAs | | InGaAs | | TEOS | SiN | |
|---|---|---|---|---|---|---|---|---|---|
| | Polishing | Rate of | Polishing | Rate of | Polishing | Rate of | Polishing | Polishing | |
| | speed | dissolution | speed | dissolution | speed | dissolution | speed | speed | |
| | (Å/min) | (Å/min) | (Å/min) | (Å/min) | (Å/min) | (Å/min) | (Å/min) | (Å/min) | Stability |
| Example 1 | 136 | 14 | 272 | 14 | 415 | 15 | 4 | 3 | OK |
| Example 2 | 195 | 15 | 390 | 15 | 595 | 15 | 5 | 5 | OK |
| Example 3 | 271 | 20 | 542 | 19 | 827 | 20 | 3 | 6 | OK |
| Example 4 | 325 | 23 | 650 | 22 | 992 | 23 | 9 | 8 | OK |
| Example 5 | 296 | 18 | 593 | 17 | 905 | 18 | 30 | 33 | OK |
| Example 6 | 278 | 20 | 557 | 19 | 850 | 20 | 7 | 3 | OK |
| Example 7 | 271 | 18 | 542 | 17 | 827 | 18 | 6 | 1 | OK |
| Example 8 | 276 | 18 | 551 | 17 | 841 | 18 | 10 | 3 | OK |
| Example 9 | 335 | 17 | 671 | 17 | 1024 | 17 | 18 | 9 | OK |
| Example 10 | 334 | 16 | 669 | 16 | 1021 | 16 | 28 | 68 | OK |
| Example 11 | 324 | 16 | 648 | 16 | 989 | 16 | 35 | 83 | OK |
| Example 12 | 319 | 19 | 638 | 18 | 974 | 19 | 4 | 8 | OK |
| Example 13 | 228 | 19 | 456 | 18 | 696 | 19 | | | OK |
| Example 14 | 192 | 16 | 384 | 16 | 586 | 16 | | | OK |
| Example 15 | 255 | 17 | 509 | 17 | 777 | 17 | | | OK |
| Example 16 | 193 | 18 | 386 | 17 | 589 | 18 | | | OK |
| Example 17 | 313 | 21 | 625 | 20 | 954 | 21 | | | OK |
| Example 18 | 215 | 18 | 429 | 17 | 655 | 18 | | | OK |
| Example 19 | 322 | 24 | 644 | 23 | 983 | 25 | | | OK |
| Example 20 | 229 | 12 | 458 | 11 | 699 | 12 | | | OK |
| Example 21 | 301 | 43 | 602 | 42 | 919 | 44 | 4 | 3 | OK |
| Example 22 | 433 | 50 | 866 | 49 | 1322 | 51 | 5 | 5 | OK |
| Example 23 | 602 | 44 | 1205 | 43 | 1839 | 45 | 3 | 6 | OK |
| Example 24 | 723 | 40 | 1446 | 38 | 2207 | 40 | 9 | 8 | OK |
| Example 25 | 734 | 43 | 1469 | 42 | 2242 | 44 | 43 | 25 | OK |
| Example 26 | 693 | 43 | 1385 | 42 | 2114 | 44 | 2 | 5 | OK |

TABLE 2-2

| | | | | | | | | Ge | | |
|---|---|---|---|---|---|---|---|---|---|---|
| | Abra- | | | | | | | | | Polishing |
| | sive | Oxidizing agent | | Salt compound | | | Electrical | Polishing | Rate of | speed/rate |
| | grains | | Concentration | | Concentration | | conductivity | speed | dissolution | of |
| | Type | Type | (mass %) | Type | (mol/L) | pH | (mS/cm) | (Å/min) | (Å/min) | dissolution |
| Example 27 | A | NaClO | 1.0 | K₂SO₄ | 0.01 | 7.0 | 13.5 | 601 | 53 | 11 |
| Example 28 | A | NaClO | 1.0 | KHCO₃ | 0.05 | 7.2 | 9.1 | 506 | 50 | 10 |
| Example 29 | A | NaClO | 1.0 | KCl | 0.1 | 7.0 | 12.0 | 670 | 42 | 16 |
| Example 30 | A | NaClO | 1.0 | KBr | 0.2 | 7.2 | 12.5 | 507 | 45 | 11 |
| Example 31 | A | NaClO | 1.0 | KI | 0.1 | 7.1 | 12.4 | 824 | 55 | 15 |
| Example 32 | A | NaClO | 1.0 | NaCl | 0.1 | 7.0 | 10.0 | 565 | 45 | 13 |
| Example 33 | A | NaClO | 1.0 | NH₃SO₄ | 0.1 | 6.7 | 28.0 | 848 | 56 | 15 |
| Example 34 | A | NaClO | 1.0 | NH₃NO₃ | 0.1 | 6.6 | 11.5 | 603 | 53 | 11 |
| Example 35 | A | NaClO | 1.0 | KNO₃ | 0.1 | 7.0 | 11.2 | 811 | 58 | 14 |
| | | H₂O₂ | 0.03 | | | | | | | |
| Example 36 | A | H₂O₂ | 0.03 | KNO₃ | 0.1 | 7.0 | 11.0 | 316 | 31 | 10 |
| Example 37 | A | — | — | KNO₃ | 0.5 | 7.0 | 44.0 | 348 | 29 | 12 |
| Comparative | A | — | — | — | — | 7.7 | 0.1 | 40 | 10 | 4 |
| Example 1 | | | | | | | | | | |
| Comparative | A | H₂O₂ | 0.3 | — | | 7.7 | 0.1 | 278 | 153 | 2 |
| Example 2 | | | | | | | | | | |
| Comparative | A | H₂O₂ | 0.3 | KNO₃ | 0.1 | 7.0 | 11.3 | 655 | 360 | 2 |
| Example 3 | | | | | | | | | | |
| Comparative | A | H₂O₂ | 0.3 | K₂SO₄ | 0.1 | 7.0 | 13.5 | 632 | 338 | 2 |
| Example 4 | | | | | | | | | | |
| Comparative | A | H₂O₂ | 0.3 | KHCO₃ | 0.1 | 7.2 | 9.1 | 549 | 318 | 2 |
| Example 5 | | | | | | | | | | |
| Comparative | A | H₂O₂ | 0.3 | KCl | 0.1 | 7.0 | 12.0 | 710 | 449 | 2 |
| Example 6 | | | | | | | | | | |
| Comparative | A | H₂O₂ | 0.3 | KBr | 0.1 | 7.2 | 12.5 | 576 | 325 | 2 |
| Example 7 | | | | | | | | | | |
| Comparative | A | H₂O₂ | 0.3 | KI | 0.1 | 7.1 | 12.4 | 843 | 474 | 2 |
| Example 8 | | | | | | | | | | |
| Comparative | A | H₂O₂ | 0.3 | NaCl | 0.01 | 7.0 | 10.0 | 630 | 329 | 2 |
| Example 9 | | | | | | | | | | |
| Comparative | A | H₂O₂ | 0.3 | (NH₄)₂SO₄ | 0.05 | 6.7 | 28.0 | 684 | 441 | 2 |
| Example 10 | | | | | | | | | | |
| Comparative | A | H₂O₂ | 0.3 | NH₄NO₃ | 0.1 | 6.6 | 11.5 | 680 | 427 | 2 |
| Example 11 | | | | | | | | | | |
| Comparative | A | H₂O₂ | 0.1 | KNO₃ | 0.2 | 7.0 | 11.2 | 580 | 240 | 2 |
| Example 12 | | | | | | | | | | |
| Comparative | A | H₂O₂ | 0.1 | Triammonium | 0.1 | 7.0 | 11.5 | 620 | 320 | 2 |
| Example 13 | | | | citrate | | | | | | |
| Comparative | A | H₂O₂ | 0.1 | — | — | 7.0 | 0.1 | 90 | 49 | 4 |
| Example 14 | | | | | | | | | | |

| | SiGe (Si:Ge = 50:50) | | GaAs | | InGaAs | | TEOS | SiN | |
|---|---|---|---|---|---|---|---|---|---|
| | Polishing | Rate of | Polishing | Rate of | Polishing | Rate of | Polishing | Polishing | |
| | speed | dissolution | speed | dissolution | speed | dissolution | speed | speed | |
| | (Å/min) | (Å/min) | (Å/min) | (Å/min) | (Å/min) | (Å/min) | (Å/min) | (Å/min) | Stability |
| Example 27 | 571 | 48 | 1142 | 46 | 1743 | 48 | | | OK |
| Example 28 | 481 | 45 | 961 | 44 | 1467 | 46 | | | OK |
| Example 29 | 637 | 38 | 1273 | 37 | 1943 | 38 | | | OK |
| Example 30 | 482 | 41 | 963 | 39 | 1470 | 41 | | | OK |
| Example 31 | 783 | 50 | 1566 | 48 | 2390 | 50 | | | OK |
| Example 32 | 537 | 41 | 1074 | 39 | 1639 | 41 | | | OK |
| Example 33 | 806 | 50 | 1611 | 49 | 2459 | 51 | | | OK |
| Example 34 | 573 | 48 | 1146 | 46 | 1749 | 48 | | | OK |
| Example 35 | 770 | 52 | 1541 | 50 | 2352 | 53 | 4 | 7 | OK |
| Example 36 | 300 | 28 | 600 | 27 | 916 | 28 | 4 | 6 | OK |
| Example 37 | 331 | 26 | 661 | 25 | 1009 | 26 | 43 | 25 | NG |
| Comparative | 38 | 9 | 76 | 9 | 88 | 9 | 5 | 5 | OK |
| Example 1 | | | | | | | | | |
| Comparative | 264 | 138 | 528 | 133 | 806 | 139 | | | OK |
| Example 2 | | | | | | | | | |
| Comparative | 622 | 324 | 1245 | 313 | 1900 | 328 | | | OK |
| Example 3 | | | | | | | | | |
| Comparative | 600 | 304 | 1201 | 294 | 1833 | 308 | | | OK |
| Example 4 | | | | | | | | | |
| Comparative | 522 | 286 | 1043 | 277 | 1592 | 289 | | | OK |
| Example 5 | | | | | | | | | |
| Comparative | 675 | 404 | 1349 | 391 | 2059 | 409 | | | OK |
| Example 6 | | | | | | | | | |
| Comparative | 547 | 293 | 1094 | 283 | 1670 | 296 | | | OK |
| Example 7 | | | | | | | | | |
| Comparative | 801 | 427 | 1602 | 412 | 2445 | 431 | | | OK |
| Example 8 | | | | | | | | | |
| Comparative | 599 | 296 | 1197 | 286 | 1827 | 299 | | | OK |
| Example 9 | | | | | | | | | |
| Comparative | 650 | 397 | 1300 | 384 | 1984 | 401 | | | OK |
| Example 10 | | | | | | | | | |
| Comparative | 646 | 384 | 1292 | 371 | 1972 | 389 | | | OK |
| Example 11 | | | | | | | | | |
| Comparative | 551 | 216 | 1102 | 209 | 1682 | 218 | 6 | 4 | OK |
| Example 12 | | | | | | | | | |
| Comparative | 589 | 288 | 1178 | 278 | 1798 | 291 | 8 | 3 | OK |
| Example 13 | | | | | | | | | |
| Comparative | 86 | 44 | 171 | 43 | 261 | 45 | 7 | 3 | OK |
| Example 14 | | | | | | | | | |

TABLE 2-3

| | Abrasive | Oxidizing agent | | Salt compound | | | Electrical |
|---|---|---|---|---|---|---|---|
| | grains | | Concentration | | Concentration | | conductivity |
| | Type | Type | (mass %) | Type | (mol/L) | pH | (mS/cm) |
| Example 38 | B | — | — | Triammonium | 0.05 | 2.0 | 6.0 |
| | | | | citrate | | | |
| Example 39 | B | — | — | Triammonium | 0.05 | 3.0 | 6.0 |
| | | | | citrate | | | |
| Example 40 | B | — | — | Triammonium | 0.05 | 5.0 | 6.0 |
| | | | | citrate | | | |
| Example 41 | B | — | — | Triammonium | 0.05 | 7.0 | 6.0 |
| | | | | citrate | | | |
| Example 42 | B | — | — | Triammonium | 0.05 | 9.0 | 6.0 |
| | | | | citrate | | | |
| Example 43 | B | — | — | Triammonium | 0.05 | 10.0 | 6.0 |
| | | | | citrate | | | |
| Example 44 | B | — | — | Triammonium | 0.05 | 12.0 | 6.0 |
| | | | | citrate | | | |
| Example 45 | B | H₂O₂ | 0.05 | Triammonium | 0.05 | 7.0 | 5.8 |
| | | | | citrate | | | |
| Example 46 | B | H₂O₂ | 0.05 | Triammonium | 0.1 | 7.0 | 11.5 |
| | | | | citrate | | | |
| Example 47 | B | H₂O₂ | 0.05 | Triammonium | 0.2 | 7.0 | 20.6 |
| | | | | citrate | | | |
| Example 48 | B | H₂O₂ | 0.08 | Triammonium | 0.25 | 7.0 | 24.6 |
| | | | | citrate | | | |
| Comparative | B | H₂O₂ | 0.1 | Triammonium | 0.05 | 7.0 | 5.8 |
| Example 15 | | | | citrate | | | |
| Comparative | B | H₂O₂ | 0.3 | Triammonium | 0.05 | 7.0 | 5.8 |
| Example 16 | | | | citrate | | | |
| Comparative | B | H₂O₂ | 1.0 | Triammonium | 0.05 | 7.0 | 5.8 |
| Example 17 | | | | citrate | | | |
| Example 48 | B | — | — | CH₃COOK | 0.1 | 7.0 | 11.3 |
| Example 49 | B | — | — | KNO₃ | 0.1 | 7.0 | 11.3 |
| Example 50 | B | — | — | K₂SO₄ | 0.1 | 7.0 | 13.5 |
| Example 51 | B | — | — | KHCO₃ | 0.1 | 7.2 | 9.1 |
| Example 52 | B | — | — | KCl | 0.1 | 7.0 | 12.0 |
| Example 53 | B | — | — | KBr | 0.1 | 7.2 | 12.5 |
| Example 54 | B | — | — | KI | 0.1 | 7.1 | 12.5 |
| Example 55 | B | — | — | NaCl | 0.1 | 7.0 | 10.0 |
| Example 56 | B | — | — | NH₄NO₃ | 0.1 | 6.6 | 11.5 |
| Example 57 | C | — | — | Triammonium | 0.05 | 7.0 | 6.0 |
| | | | | citrate | | | |

| | Ga | | | InGaAs | | |
|---|---|---|---|---|---|---|
| | Polishing | Rate of | Surface | Polishing | Rate of | Surface |
| | speed | dissolution | roughness | speed | dissolution | roughness |
| | (Å/min) | (Å/min) | (Å) | (Å/min) | (Å/min) | (Å) |
| Example 38 | 122 | 51 | 8 | 164 | 21 | 8 |
| Example 39 | 159 | 21 | 8 | 318 | 21 | 8 |
| Example 40 | 185 | 18 | 8 | 370 | 18 | 8 |
| Example 41 | 245 | 19 | 7 | 490 | 19 | 7 |
| Example 42 | 287 | 22 | 8 | 574 | 22 | 8 |
| Example 43 | 356 | 21 | 7 | 712 | 21 | 7 |
| Example 44 | 407 | 18 | 6 | 814 | 18 | 6 |
| Example 45 | 456 | 28 | 7 | 912 | 28 | 7 |
| Example 46 | 524 | 33 | 8 | 1248 | 33 | 8 |
| Example 47 | 611 | 48 | 8 | 1458 | 48 | 8 |
| Example 48 | 629 | 48 | 8 | 1458 | 48 | 8 |
| Comparative | 711 | 121 | 22 | 1022 | 41 | 22 |
| Example 15 | | | | | | |
| Comparative | 620 | 170 | 19 | 1240 | 170 | 19 |
| Example 16 | | | | | | |
| Comparative | 1150 | 324 | 35 | 2300 | 324 | 35 |
| Example 17 | | | | | | |
| Example 48 | 285 | 22 | 7 | 570 | 22 | 7 |
| Example 49 | 285 | 22 | 8 | 570 | 22 | 8 |
| Example 50 | 240 | 21 | 6 | 481 | 21 | 6 |
| Example 51 | 202 | 18 | 7 | 405 | 18 | 7 |
| Example 52 | 268 | 19 | 7 | 536 | 19 | 7 |
| Example 53 | 203 | 20 | 8 | 405 | 20 | 8 |
| Example 54 | 329 | 23 | 7 | 659 | 23 | 7 |
| Example 55 | 226 | 20 | 7 | 452 | 20 | 7 |
| Example 56 | 241 | 13 | 7 | 482 | 13 | 7 |
| Example 57 | 242 | 19 | 7 | 484 | 19 | 7 |

TABLE 2-4

| | | | | | | | | SiGe (Si:Ge = 50:50) | | |
|---|---|---|---|---|---|---|---|---|---|---|
| | Abrasive | Oxidizing agent | | Salt compound | | | Electrical | Polishing | Rate of | Surface |
| | grains | | Concentration | | Concentration | | conductivity | speed | dissolution | roughness |
| | Type | Type | (mass %) | Type | (mol/L) | pH | (mS/cm) | (Å/min) | (Å/min) | (Å) |
| Comparative | A | — | — | — | — | 7.0 | 0.1 | 232 | <5 | 21 |
| Example 18 | | | | | | | | | | |
| Example 41 | B | — | — | Triammonium | 0.05 | 7.0 | 6.0 | 490 | 19 | 7 |
| | | | | citrate | | | | | | |

| | SiGe (Si:Ge = 15:85) | | | GaAs | | |
|---|---|---|---|---|---|---|
| | Polishing | Rate of | Surface | Polishing | Rate of | Surface |
| | speed | dissolution | roughness | speed | dissolution | roughness |
| | (Å/min) | (Å/min) | (Å) | (Å/min) | (Å/min) | (Å) |
| Comparative | 232 | <5 | 28 | 232 | <5 | 23 |
| Example 18 | | | | | | |
| Example 41 | 490 | 19 | 7 | 490 | 19 | 7 |

As shown in Table 2-1 and Table 2-2, it was found that in a case in which the polishing compositions of Examples 1 to 37 were used, the polishing speeds for the Ge substrate, SiGe substrate (Si:Ge=50:50), GaAs substrate, and InGaAs substrate (In:Ga:As=26.5:23.5:50.0) were increased, while dissolution of the Ge substrate, SiGe substrate (Si:Ge=50:50), GaAs substrate, and InGaAs substrate (In:Ga:As=26.5:23.5:50.0) was suppressed.

Furthermore, it was found from the results shown in Table 2-3 that in a case in which the polishing compositions of Examples 38 to 57 were used, the polishing speeds for the Ge substrate and the InGaAs substrate (In:Ga:As=26.5:23.5:50.0) were increased, while dissolution of the Ge substrate and the InGaAs substrate (In:Ga:As=26.5:23.5:50.0) was suppressed.

Furthermore, it was found from the results shown in Table 2-4 that in a case in which the polishing composition of Example 41 was used, the polishing speeds for the SiGe substrate (Si:Ge=50:50), SiGe substrate (Si:Ge=15:85) and GaAs substrate were increased, while dissolution of the SiGe substrate (Si:Ge=50:50), SiGe substrate (Si:Ge=15:85) and GaAs substrate was suppressed.

Furthermore, it was found that the polishing compositions of Examples 1 to 36 had excellent stability.

### Examples 58 and 59, and Comparative Examples 19 to 22

Polishing compositions were produced in the same manner as described above, except that the compositions were changed to the compositions described in the following Table 3. The polishing speeds for a SiGe substrate and a Poly-Si substrate were measured using the polishing compositions thus obtained. The polishing speed for the Poly-Si substrate was evaluated by determining the film thicknesses obtainable before and after polishing using a light interference type film thickness analyzer (manufactured by Dainippon Screen Manufacturing Co., Ltd., product No.: Lambda S), and dividing the difference between the values by the polishing time. The measurement results are presented in the following Table 3.

TABLE 3

| | | | | | | | PVP | | | SiGe | Poly-Si |
|---|---|---|---|---|---|---|---|---|---|---|---|
| | Abrasive grains | | Oxidizing agent | | Salt compound | | Concen- | | Electrical | (Si:Ge = 50:50) | Polishing |
| | | Concentration | | Concentration | | Concentration | tration | | conductivity | Polishing speed | speed |
| | Type | (mass %) | Type | (mass %) | Type | (mol/L) | (g/L) | pH | (mS/cm) | (Å/min) | (Å/min) |
| Comparative | A | 0.9 | — | — | — | — | — | 10.3 | 0.7 | 185 | 658 |
| Example 19 | | | | | | | | | | | |
| Comparative | A | 0.9 | — | — | — | — | 0.1 | 10.3 | 0.7 | 94 | 63 |
| Example 20 | | | | | | | | | | | |
| Comparative | A | 0.9 | — | — | — | — | 0.5 | 10.3 | 0.7 | 66 | 57 |
| Example 21 | | | | | | | | | | | |
| Comparative | A | 0.9 | — | — | — | — | 1.0 | 10.3 | 0.7 | 92 | 49 |
| Example 22 | | | | | | | | | | | |
| Example 58 | A | 0.9 | — | — | NH₄NO₃ | 1 | — | 10.3 | 2.2 | 311 | 819 |
| Example 59 | A | 0.9 | — | — | NH₄NO₃ | 1 | 1.0 | 10.3 | 2.3 | 245 | 64 |

It was found from the results indicated in Table 3 that in a case in which the polishing compositions of Examples 58 and 59 were used, the polishing speeds for the SiGe substrate (Si:Ge=50:50) were increased. In regard to Example 59 in which polyvinylpyrrolidone had been added, it was also found that the polishing speed for the Poly-Si substrate was suppressed.

The present patent application is based on JP 2014-200287 filed on Sep. 30, 2014, the entire disclosure of which is incorporated herein by reference.

1. A polishing composition used for polishing an object of polishing having a layer containing a high mobility material with higher carrier mobility than that of Si, the polishing composition comprising:
abrasive grains; and
at least one salt compound selected from the group consisting of a salt of a monovalent acid, a salt of a divalent acid, a salt of a trivalent acid, and a halide salt,
wherein the polishing composition has an electrical conductivity of 1 mS/cm or higher, and a content of hydrogen peroxide of less than 0.1% by mass.

2. The polishing composition according to claim 1, wherein the high mobility material is at least one of a Group III-V compound containing arsenic (As), and a Group IV compound containing germanium (Ge).

3. The polishing composition according to claim 1, wherein the high mobility material is at least one selected from the group consisting of Ge, SiGe having a Ge content of 10% by mass or more, GaAs having an As content of 10% by mass or more, InAs, AlAs, InGaAs, InGaAsP, AlGaAs, and InAlGaAs.

4. The polishing composition according to claim 1, wherein the abrasive grains are surface-modified abrasive grains.

5. The polishing composition according to claim 1, further comprising an oxidizing agent containing a halogen atom.

6. The polishing composition according to claim 1, wherein the polishing composition has a pH of from 2.5 to 12.

7. The polishing composition according to claim 1, wherein the electrical conductivity is 40 mS/cm or less.

8. A method for producing a polishing composition, the method comprising mixing abrasive grains with at least one salt compound selected from the group consisting of a salt of a monovalent acid, a salt of a divalent acid, a salt of a trivalent acid, and a halide salt.

9. A polishing method comprising polishing an object of polishing having a layer containing a high mobility material, using the polishing composition according to claim 1.

10. A polishing method comprising polishing an object of polishing having a layer containing a high mobility material, using the polishing composition obtained by the method according to claim 8.
